(19) United States
(12) Patent Application Publication
(10) Pub. No.: US 2013/0048675 A1
(43) Pub. Date: Feb. 28, 2013

(54) THERMAL BEVERAGE DISPENSER

(71) Applicant: Daniel Scott Amundson, Winona, MN (US)

(72) Inventor: Daniel Scott Amundson, Winona, MN (US)

(21) Appl. No.: 13/221,213

(22) Filed: Aug. 30, 2011

(51) Int. Cl. B67D 7/80; B67D 7/84

(52) U.S. Cl. 222/146.6; 222/185.1

(57) ABSTRACT

A thermal beverage hopper is provided that includes a structure having a top (12) and a bottom (14), a base (16) with feet (14), rotatably joined with a mid-section (22) attached to hopper (20) containing cavity (24) fillable with a beverage. A thermal rod (38) comprised of a volumetric curve (44) enclosing a hollow space (46) filled with a thermal fluid (50) and having a cap (48) at proximal end (40) and distal end (42) and a coating (52) containing one or more mesh baffles (54) controls temperature of a beverage by being inserted into socket (28) and supported by opening (36) in cover (34). A spigot (32) sealed by a washer (30) drains beverage flowing through a sluice (26) into a consumer receptacle.

### BACKGROUND

The present application relates to beverage dispensing, in particular to the type of beverage dispensing that occurs in commercial business establishments and at gatherings where groups of persons congregate.

Beverage sales are the staple to most of a restaurant's business. Businesses gain huge margins on sodas, beer and other variety of cold, hot and room temperature exotic beverages. A variety of drink dispensers, drink machines, water stations and other sundry dispensers are known.

The largest majority of sundry dispensers are dependent upon a wait person delivering the dispenser to a table of consumers and having to return to the table, frequently, to refill the dispenser. The most commonly known and used dispenser is the pitcher. Pitchers are used to serve beverages best consumed at the specific temperature at which they are delivered to the table. The problem being most pitchers, even when designed to hold a beverage at its proper serving temperature, are not efficient. In many instances ice is added to the beverage to keep it cold, however this diminishes the quality and taste of the beverage by diluting it. In addition, it is very uncommon to have an electrical power source at the majority of communal tables to maintain a pitcher, containing a beverage, at a cold or hot temperature by some electromechanical means. Thus it is not possible to have a large supply of correct serving temperature beverage available, at a table, for consumers to freely help themselves to drink as they please.

In some instances, contrivances are made to maintain cold serving temperatures in these table top dispensers. In the majority of cases these devices require the periodic addition of ice to maintain thermal regulation. This is a labor intensive and messy process. In some cases where ice is not used, an object is chilled and submerged in the drink leaving it inaccessible until the drink has been consumed.

Accordingly it is needed to have a thermal beverage hopper which overcomes these limitations as noted above, with regard to pitchers and other drink dispensers.

### SUMMARY

In at least one embodiment a thermal beverage dispenser is provided that includes a top and a bottom. The thermal beverage dispenser has a weighted stable base shaped in a convex conical fashion the bottom having a recessed flat area on which feet comprised of a firm semi spherical elastomer are mounted by adhesive or some other means to the flat area. The feet are only visible if the base is inverted. Thus the base, in the base's upright mode, has two stability factors. The factors are the feet on which it rests and the outer ring at the bottom of the base. The outer ring of the base clears the flat surface the base sits on, by a small dimension such as 0.03 inch. The top of the base has a recessed outer surface, at the top, over which a mid-section is mounted in a rotatable fashion.

In addition, the dispenser is comprised of a transparent or translucent plastic material attached rigidly to the mid-section and contains a fluid tight cavity for holding a beverage. A beverage can be dispensed from the hopper by traveling through a sluice when the spigot is opened. A washer or similar compression fit seals a fluid tight connection with the spigot and the mid-section. The mid-section contains a socket for positioning a thermal rod.

Further, a removable cover is comprised of a transparent or translucent plastic material and fashioned into a surface forming an upside down truncated cone with an opening. The cover sits securely on top of and engages a hopper via a right angle joint. The opening serves the means of supporting the thermal rod at the distal end of the thermal rod.

The thermal rod has a proximal end which engages the socket in the mid-section and a distal end supported through the opening of a cover. The thermal rod is constructed of a volumetric curve containing a hollow space. Within the hollow space one or more baffles partially separate one section of the thermal rod from another. In one embodiment the thermal rod is constructed of metal or any other suitable material suitable for non-contaminating contact with a variety of beverages. Caps are attached to the volumetric curve by welding or any other suitable means to form a fluid tight seal. Prior to closure, the hollow space of the thermal rod is filled to 90 percent capacity with a thermal fluid. An electroplated coating or other suitable coating may be applied to the exterior of the thermal rod. The coating serves a means of creating a contact surface suitable for non-contaminating contact with a variety of beverages.

An object of the invention is to provide a thermal beverage dispenser whose contents can be kept temperature controlled.

An object of this invention is to provide a thermal beverage dispenser not dependent on a wait person to have to immediately re-service.

An object of this invention is to provide a thermal beverage dispenser not dependent on an electrical power source to maintain its temperature.

An object of this invention is to provide a large supply of temperature correct beverage at a consumers table.

An object of this invention is to improve relations between restaurant consumers and there patrons.

An object of the invention is to provide a thermal beverage dispenser with a temperature controlling mechanisms that does not require ice.

An object of the invention is to provide a thermal beverage dispenser with a temperature controlling device that is easily accessible and can be changed without having to reach into the beverage or empty the dispenser to replace.

Additional aspects of the present invention will be apparent in view of the description which follows.

### BRIEF DESCRIPTION OF THE FIGURES

FIG. 1 is a perspective view of a thermal beverage dispenser.

FIG. 2 is a front view thereof.

FIG. 3 is a back view thereof.

FIG. 4 is a left side view thereof.

FIG. 5 is a right side view thereof.

FIG. 6 is a top view thereof.

FIG. 7 is a bottom view thereof.

FIG. 8 is a section view of a thermal rod.

FIG. 9 is a section view taken from FIG. 8.

### DETAILED DESCRIPTION OF THE INVENTION

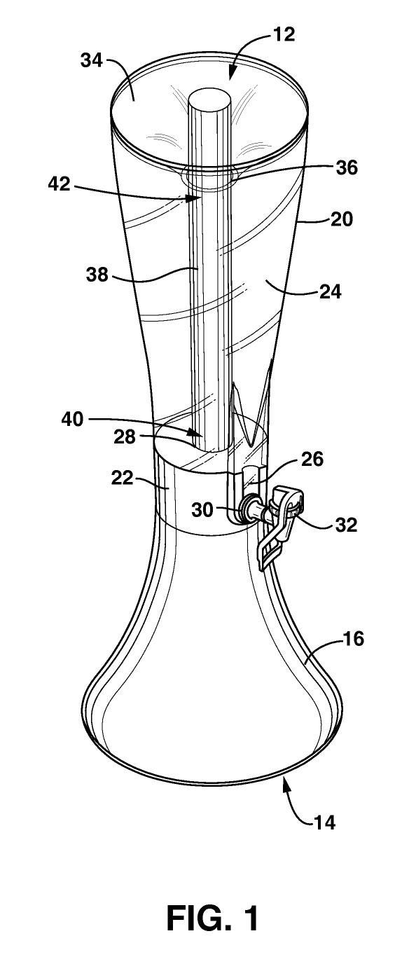

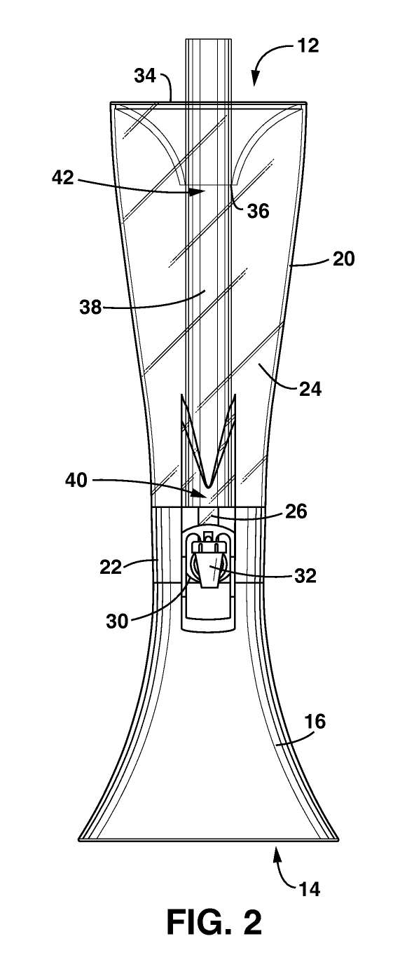

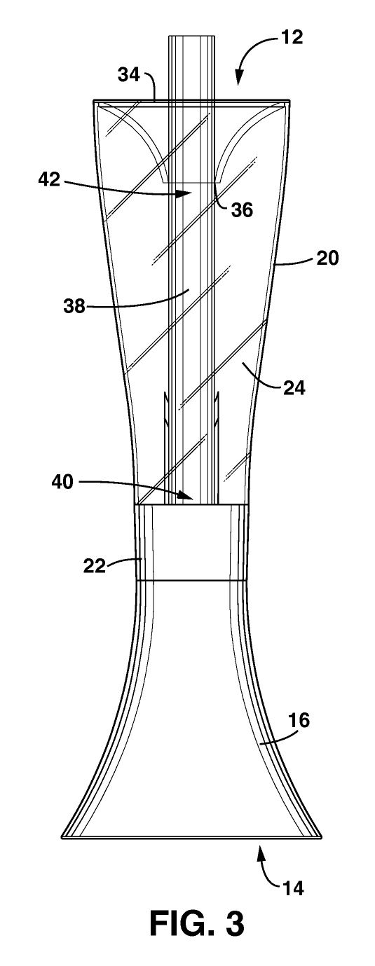

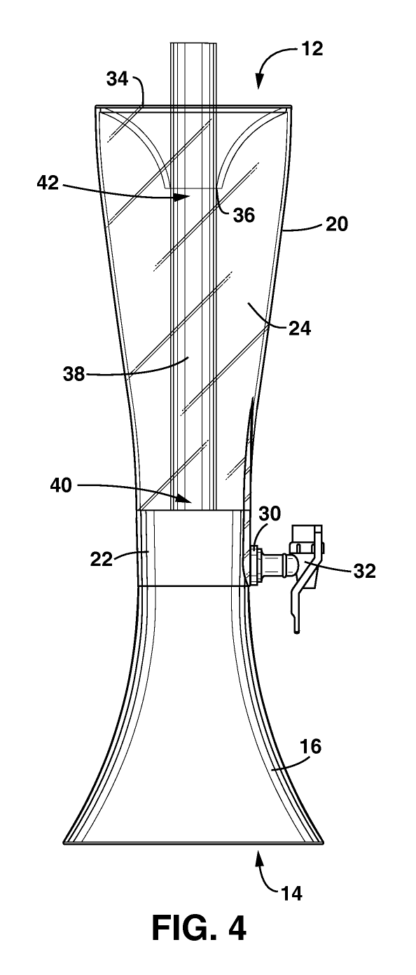

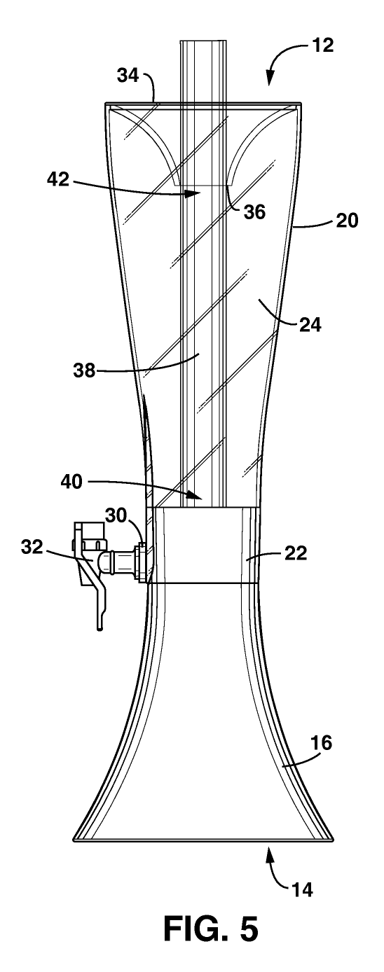

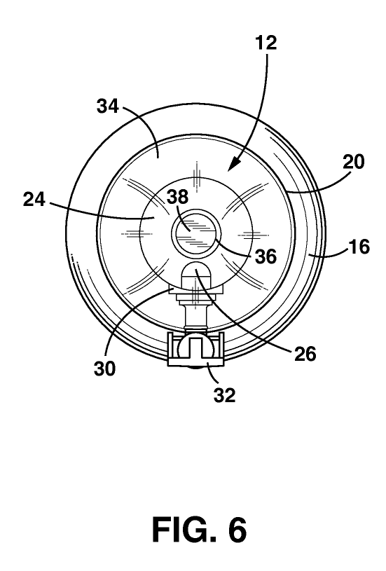

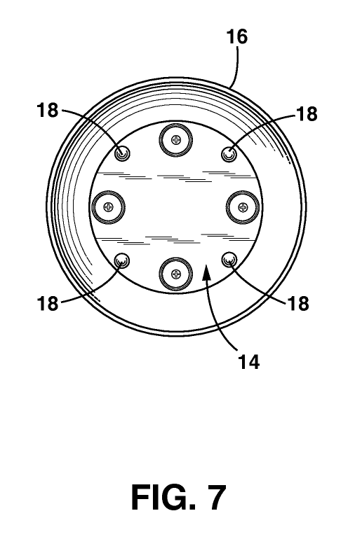

Referring to FIG. 1 through FIG. 7 a thermal beverage dispenser according to at least one embodiment is provided that includes a top 12 and a bottom 14. A weighted stable base 16 is shaped in a convex conical fashion the bottom 14 has a recessed flat area on which feet 18 comprised of a firm semi spherical elastomer are mounted by adhesive or some other means to the flat area. The feet 18 are only visible if the base 16 is inverted. Thus the base 16, in the base's 16 upright mode, has two stability factors. The factors are the feet 18 on which it rests and the outer ring at the bottom 14 of base 16. The outer ring of base 16 clears the flat surface the base 16 sits on, by a small dimension such as 0.03 inch. The top of base 16 has a recessed outer surface, at the top, over which the mid-section 22 is mounted in a rotatable fashion.

Hopper 20 may be comprised of a transparent or translucent plastic material that is attached rigidly to mid-section 22 and contains a fluid tight cavity 24 for holding a beverage. A beverage can be dispensed from hopper 20 by traveling through a sluice 26 when spigot 32 is opened. A washer 30 seals a fluid tight connection of the spigot 32 with the mid-section 22. Mid-section 22 contains a socket 28 for positioning thermal rod 38, more of which will be spoken about later.

A removable cover 34 may be comprised of a transparent or translucent plastic material is fashioned into a surface forming an upside down truncated cone with an opening 36. The cover 34 sits securely on top of and engages hopper 20 via a right angle joint. The opening 36 serves the means of supporting thermal rod 38 at the distal end of thermal rod 38.

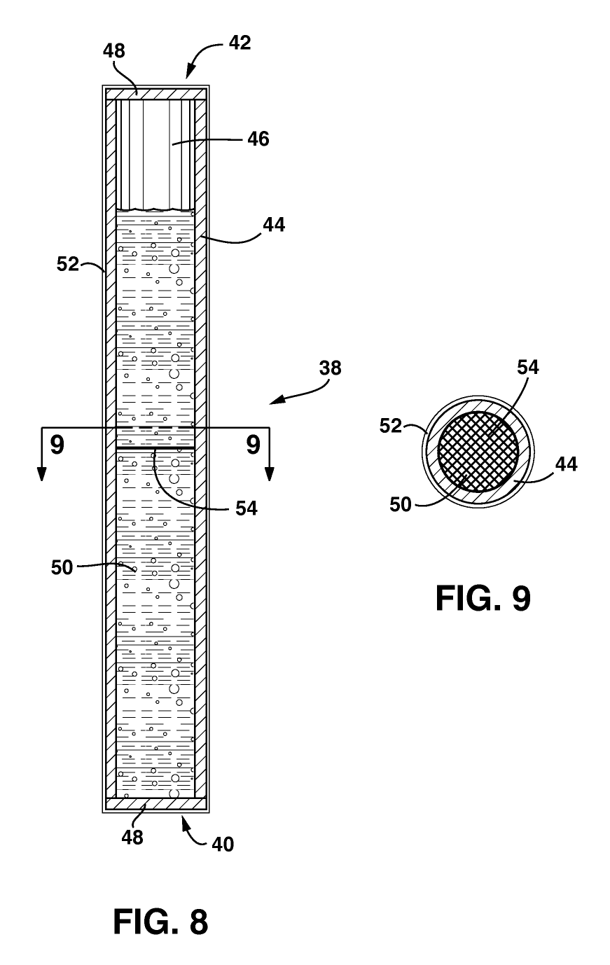

FIG. 8 is a section view of the thermal rod 38. The thermal rod 38 has a proximal end 40 which engages socket 28 in mid-section 22 and a distal end 42 supported through the opening 36 of cover 34. The thermal rod 38 is constructed of a volumetric curve 44 containing a hollow space 46. In one embodiment the thermal rod is constructed of metal or any other suitable material. Caps 48 are attached to volumetric curve 44 by welding or any other suitable means to form a fluid tight seal. Prior to closure, hollow space 46 of thermal rod 38 is filled to 90 percent capacity with a thermal fluid 50. An electroplated coating 52 or other suitable coating 52 may be applied to the exterior of thermal rod 38. Coating 52 serves a means of creating a contact surface suitable for non-contaminating contact with a variety of beverages.

Thermal rod 38 is cooled to the freezing of thermal fluid 50 to a solid state by any means. Then the thermal rod 38 is inserted into hopper 20 for use.

In one embodiment as illustrated in FIG. 8 and FIG. 9 one or more mesh baffles 54 are fixed inside volumetric curve 44 at one or more locations to create at least first and second vertically layered sections. When thermal fluid 50 begins to rise in temperature and melt from its frozen state. Solid matter tends to rise in hollow space 46 while warmed thermal fluid 50 settles, thus producing a stratified cooling in cavity 24 where the coldest temperature is at the top. One or more mesh baffles 54 prevents such stratification by holding the solid matter, of melting thermal fluid 50, in place within the vertical layered sections, lower in the hollow space 46 and aids to equalize cooling effect from volumetric curve 44 to cavity 24 where beverage is dispensed from the bottom of hopper 20 by spigot 32.

The present invention is described in the following Examples, which are set forth to aid in the understanding of the invention, and should not be construed to limit in any way the scope of the invention as defined in the claims which follow thereafter.

### Examples

In operation the thermal beverage dispenser is positioned on a table via the base 16. The open hopper 20 is filled with a beverage to a point below the bottom of cover 34.

Cover 34 is placed in position on hopper 20. Thermal rod 38 is removed from a temperature controlled storage and inserted through opening 36, in cover 34, until the proximal end 40 is engaged in socket 28 in mid-section 22. The thermal rod 38 and the opening 36 may be dimensioned so that a gap is maintained between the rod 38 and the opening 36.

Consumers are able to rotate the spigot 32 in a 360-degree rotation about the base 16 to fill their individual glass or mug.

The entire assembly can be remove from the base 16 transported to a fill location and returned to the base 16 for further consumer consumption.

While the foregoing invention has been described in some detail for purposes of clarity and understanding, it will be appreciated by one skilled in the art, from a reading of the disclosure, that various changes in form and detail can be made without departing from the true scope of the invention.

What is claimed is:

1. A beverage dispenser comprising:
a base at a bottom end of the dispenser;
a hopper coupled to the base at an opposite end of the dispenser, wherein the hopper has a top end and a bottom end opposite the top end, the hopper comprising a spigot at the bottom end of the bopper and a conical cover at the top end of the cover, the conical cover having an opening therein, the hopper having a mid-section at the bottom end with a socket therein; and
a thermal rod removably inserted into the socket in the mid-section of the hopper through the opening in the cover so as to be in communication with a beverage located in the cavity of the hopper.

2. The dispenser of claim 2, wherein the base comprises a weighted base having a convex conical shape.

3. The dispenser of claim 2, wherein the base comprises at least a two stability factors.

4. The dispenser of claim 3, wherein at least one of the stability factors comprises a ring at the bottom end of the base that when the dispenser is located on a surface clears the surface by a minimum amount.

5. The dispenser of claim 1, wherein the hopper is rotatably coupled to the base.

6. The dispenser of claim 5, wherein the hopper is capable of being rotated 360 degrees relative to the base.

7. The dispenser of claim 1, wherein the rod has a length such that an end of the rod extends out from the opening in the cover.

8. The dispenser of claim 1, the hopper comprising a removable cover.

9. The dispenser of claim 1, wherein the thermal rod is constructed of a volumetric curve containing a hollow space with a thermal fluid located therein.

10. The dispenser of claim 1, wherein the hopper is formed into an upside down truncated cone with an opening.

11. The dispenser of claim 1, wherein the hopper is formed from a transparent or translucent material.

12. The dispenser of claim 1, wherein the thermal rod contains a hollow space with a thermal fluid located therein, the thermal rod comprising at least one mesh baffle located within the hollow space therewith creating at least first and second vertically layered sections within the hollow space.

13. A beverage dispenser comprising:
a weighted base at a bottom end of the dispenser;
a clear hopper formed into an upside down truncated cone, the hopper rotatably coupled to the base at an opposite end of the dispenser, wherein the hopper has a top end and a bottom end opposite the top end, the hopper comprising a spigot at the bottom end of the bopper and a conical cover at the top end of the cover, the conical cover having an opening therein, the hopper having a mid-section at the bottom end with a socket therein; and
a thermal rod removably inserted into the socket in the mid-section of the hopper through the opening in the cover so as to be in communication with a beverage located a cavity of the hopper.

14. The dispenser of claim 13, wherein the base comprises at least a two stability factors.

15. The dispenser of claim 14, wherein at least one of the stability factors comprises a ring at the bottom end of the base that when the dispenser is located on a surface clears the surface by a minimum amount.

16. The dispenser of claim 13, wherein the hopper is capable of being rotated 360 degrees relative to the base.

17. The dispenser of claim 13, wherein the rod has a length such that an end of the rod extends out from the opening in the cover.

18. The dispenser of claim 13, the hopper comprising a removable cover.

19. The dispenser of claim 13, wherein the thermal rod is constructed of a volumetric curve containing a hollow space with a thermal fluid located therein.

20. The dispenser of claim 13, wherein the thermal rod contains a hollow space with a thermal fluid located therein, the thermal rod comprising at least one mesh baffle located within the hollow space therewith creating at least first and second vertically layered sections within the hollow space.
